(19) United States
(12) Patent Application Publication
(10) Pub. No.: US 2024/0399303 A1
(43) Pub. Date: Dec. 5, 2024

(54) RECOVERING AMMONIA FOR EXAMPLE FROM COMPOSTING

(71) Applicant: ComFerm Holding ApS, Højbjerg (DK)

(72) Inventor: Pia Strunge Folkmann, Silkeborg (DK)

(73) Assignee: ComFerm Holding ApS, Højbjerg (DK)

(21) Appl. No.: 18/699,152

(22) PCT Filed: Oct. 3, 2022
(86) PCT No.: PCT/DK2022/050201

§ 371 Date: Apr. 5, 2024

(30) Foreign Application Priority Data
Oct. 6, 2021 (DK) PA202170496

(51) Int. Cl. B01D 53/58; B01D 5/00; B01D 19/00; B01D 53/00; B01D 53/14; C01C 1/10; C01C 1/12; C05F 17/10; C05F 17/90

(52) U.S. Cl. CPC B01D 53/58; B01D 5/0069; B01D 19/0005; B01D 53/002; B01D 53/1418; C01C 1/10; C01C 1/12; C05F 17/15; C05F 17/90; B01D 2257/406

(57) ABSTRACT

The invention relates to a process for recovering ammonia from an initial aqueous mixture comprising ammonium ions and ammonium salts, the process comprising providing an initial aqueous mixture, desorbing ammonia using humid, heated air to obtain a desorbing liquid phase and a desorbing gas phase, separating the desorbing liquid phase, mixing the desorbing gas phase with a capture gas to obtain a gas mixture, and condensing the gas mixture to obtain a condensate comprising ammonium ions and salt, and an outlet gas. The desorbing liquid phase comprises ammonium ions and ammonium salts in a total concentration of less than 100 ppm. The capture gas comprises carbon dioxide in an amount of at least 50,000 ppm. The total concentration of ammonium ions and ammonium salts in the condensate is higher than the total concentration in the initial aqueous mixture. The invention further relates to a system for performing an ammonium recovery process, a composting system, a composting process and a system for composting and recovering ammonia.

### FIELD OF INVENTION

The invention relates to a process for recovering ammonia in accordance with the claims.

### BACKGROUND

Waste streams contain several components which are desirable to recover and/or separate from each other. The components might have a valuable later use. Alternatively or in addition, the components may be troublesome for later processing of the waste stream or have a negative environmental impact, hence release of such components to the environment should be prevented. However, recovery processes might be ineffective and/or non-efficient and costly due the need for additional equipment and/or additional reagents and/or the energy consumption required to perform the process(es).

It is an object of one embodiment of the present invention to provide a process for recovering ammonia from a waste stream, which may solve the above problems.

### SUMMARY

An aspect relates to a process for recovering ammonia from an initial aqueous mixture comprising ammonium ions and ammonium salts, the process comprising the steps of providing an initial aqueous mixture, desorbing ammonia using humid, heated air to obtain a desorbing liquid phase and a desorbing gas phase, separating the desorbing liquid phase, mixing the desorbing gas phase with a capture gas to obtain a gas mixture, and condensing the gas mixture to obtain a condensate comprising ammonium ions and salt, and an outlet gas. The desorbing liquid phase comprises ammonium ions and ammonium salts in a total concentration of less than 100 ppm. The capture gas comprises carbon dioxide in an amount of at least 50,000 ppm. The total concentration of ammonium ions and ammonium salts in the condensate is higher than the total concentration in the initial aqueous mixture.

The inventive process may in various embodiments provide several advantages over prior art involving an efficient and effective process for recovering ammonia.

Ammonia may cause significant environmental issues if not recovered, such as air and water pollution. Hence, regulations on ammonia release exist in order to prevent excessive nutrients to be discharged into the nature.

Also, ammonia is a valuable nitrogen resource which may be used for example as fertilizer or for further conversion into valuable nitrogen-containing products. Thus, there is a commercial interest and need for an economical and energy efficient process to provide or recover ammonia.

The present invention makes it possible to recover ammonia from an aqueous mixture. An initial aqueous mixture is provided comprising ammonium ions and ammonium salts. Ammonia gas may react with water forming ammonium ions. Also, the ammonium salts may dissociate into the corresponding ions. Hence, the relative content of ions and salts may vary according to the dissociation equilibria of the ammonium salts.

The ammonia is recovered using desorption and condensation. As understood here, “desorption” is a process where a substance is released through a surface, such as when one component of a liquid stream moves by mass transfer into a gas phase through the liquid-gas interface. A desorption process could also be referred to as a stripping process.

As understood here, a “condensate” is the result of a condensation of gas into liquid, i.e. the result of gas being converted into liquid.

Ammonia is desorbed from the initial aqueous mixture into the desorbing gas phase. An advantage of the inventive process is, that it makes use of humid, heated air for facilitating said desorption process, i.e. a readily available and environmentally friendly resource. By applying air which has both been heated and humidified, the desorption is highly efficient. Also, the advantageous use of heated, humid air could enable one to omit pH regulation during the desorption. As a consequence of the efficient desorbing, the resulting desorbing liquid phase is primarily harmless water with less than 100 ppm ammonium ions and ammonium salts left, and may thereby comply with regulations for release, or even better, in advantageous embodiments, be re-used in the system where water is needed, e.g. for humidifying air to the desorber, or for use as absorption water described below.

The desorbing gas phase is mixed with capture gas comprising carbon dioxide in an amount at least 50,000 ppm to achieve a gas mixture, which is cooled in order to form a condensate and outlet gas. The inventive process makes use of a capture gas comprising carbon dioxide. Carbon dioxide is an abundant and readily available source. Carbon dioxide is a natural residual product. The capture gas comprising carbon dioxide may be provided by enriching a gas with carbon dioxide. Ideally, the capture gas may be provided directly from a process where suitable gas is a residual product, such as a combustion process, a fermentation process etc. Thus, the present capture gas comprising carbon dioxide may be a cheaper and more environmentally friendly alternative to other gasses comprising an acidic source.

Also, the process advantageously facilitates ammonium recovery as ammonium ion and ammonium salts being based on ions and salts already provided in the initial aqueous mixture and a source of gaseous carbon dioxide, also being a readily available and environmentally friendly resource.

Furthermore, the process provides for an energy-efficient recovery of ammonia compared to other processes including highly energy-consuming process steps. The present invention provides for a process for recovering ammonia, which is not harmful to the environment. The inventive process may for example provide recovery of ammonia of organic origin, e.g. plant-based or animal-based, e.g. waste from plant farms, greenhouses, gardens, fishery, animal farms, food production, food distribution, etc., e.g. vegetable production waste, feed production waste, slaughterhouse waste, liquid manure and slurry, biogas, etc., as long as ammonia, ammonium ions or ammonium salts are included in the initial aqueous mixture or initial gas.

The concentration of ammonium ions and ammonium salts may be measured using ammonium ion-selective electrodes or ammonia sensors. An ammonium ion-selective electrode provides a direct measure of the total ammonium content. Ammonia sensor provides a measure of the total ammonium content by measuring ammonia gas formed during pH regulation.

In an embodiment the initial aqueous mixture comprises ammonium ions and ammonium salts in a total concentration of at least 1000 ppm, such as at least 2500 ppm, e.g. more than 5000 ppm, for example at least 10,000 ppm.

In an embodiment the ammonium salts comprise ammonium bicarbonate (NH4HCO3), ammonium carbonate ((NH4)2CO3), ammonium carbamate (NH2COONH4) or a combination thereof.

The process advantageously facilitates ammonium recovery as ammonium ions and ammonium salts being based on ions and salts already provided in the initial aqueous mixture and a source of gaseous carbon dioxide. Salts based on ammonia and carbon dioxide have an advantageously high water-solubility, hence, unintended precipitation during processing of salts having low solubility may be avoided. Also, salts based on ammonia and carbon dioxide may be an attractive intermediate product for further processing into valuable nitrogen-containing substances or for further processing in order to recover ammonium gas.

In an embodiment the concentration of ammonium ions and ammonium salts in the condensate is at least 2 times higher than the concentration in the initial aqueous mixture, such as at least 3 times higher, such as at least 4 times higher, such as at least 5 times higher.

The inventive process provides for a desirable up-concentration of ammonium ions and ammonium salts, whereby less volume comprising the valuable nitrogen-containing compounds is to be handled. The up-concentration should not cause issues, such as unintended precipitation. The degree of up-concentration may be controlled by adjusting the humidity and temperature of the humid, heated air, by adjusting the carbon dioxide content of the capture gas or by using desorbing equipment with varying dimensions. The concentration of ammonium ions and salts may desirably be increased until issues may arise, such as unintended precipitation.

Also, the process facilitates an advantageous volume-reduction of the initial aqueous mixture to the condensate having a significant lower volume to be handled. At the same time, the process is highly effective and efficient in recovering ammonia, and thus advantageously enables that any separated water, i.e. effluent, can be returned to the environment.

The condensate could be desorbed again, such as by passing the condensate through the desorber again to achieve a further up-concentration, or by adding an extra desorbing column to the system where through the condensate is passed. The process may be repeated in an iterative process, such as by repeating the process two, three, four, five or six times. The process may also be repeated in a system comprising multiple desorbers, such as two, three, four, five or six desorbers.

The concentration of ammonium ions and ammonium salts may desirably be increased until issues may arise, such as unintended precipitation.

In an embodiment the desorbing liquid phase comprises less than 50 ppm of ammonia, such as less than 40 ppm of ammonia, such as less than 20 ppm of ammonia, such as less than 10 ppm of ammonia, such as less than 8 ppm.

Advantageously, the process enables that the separated water, i.e. the desorbing liquid phase may fulfill usual environmental protection standards with respect to content of ammonia.

In an embodiment the desorber is a packed column or trayed column. The process of desorbing may be performed in desorbing columns comprising a liquid inlet, a liquid outlet, a gas inlet and a gas outlet. The dimensions of a desorbing column may vary from laboratory scale column sizes to industrial scale towers. A desorber column may have various internal designs. The choice of which desorber column to use may depend on the setup and the composition of the initial aqueous mixture.

Packed column, also sometimes referred to as packed stripper or packed bed stripper, may be desirable to use in a smaller setup as they provide a relative higher interfacial contact area for desorption, whereby shorter columns and/or columns with a smaller diameter could be used without compromising the separation efficiency. Packed columns may be provided with a structured packing, with a random packing or a combination. A structured packing might reduce the edge effect, which might occur near the internal surface of the column. The edge effect refers to liquid or gas by-passing the packing material, whereby the efficiency of the desorbing process is decreased. By using a structured packing, the packing material is closely packed towards the internal surface of the column, thereby diminishing the edge effect. In an embodiment of the invention, the desorber is a structured, packed column, i.e. a column with a structured packing.

Trayed columns, also sometimes referred to as trayed towers, are usually cheaper to build. Trayed columns can run with a high liquid rate. Also, trayed columns may more easily be cleaned. Thus, if the initial aqueous mixture has a certain solid content it could be advantageous to use a trayed column. Or if the process is running on a large scale, it could be desirable to use a trayed column. However, the inventive process is by no means limited to any specific type of desorbing equipment.

In an embodiment the humid, heated air has a relative humidity of more than 80%, such as more than 85%, such as more than 90%, such as about 95%. An advantage of using air having a high humidity could be that an efficient desorption of ammonia from the initial aqueous mixture to desorbing gas phase is achieved. If the humidity is too low, an undesirable amount of ammonia will remain in the desorbing liquid phase. Humid, heated air is provided to the desorber via a gas inlet. The humid, heated air might be provided by passing heated air through a humidifier. Alternatively, air might be passed through equipment able to both heat and humidify in order to achieve the humid, heated air.

In an embodiment the humid, heated air has a temperature of between 50 and 75 degrees Celsius, such as between 50 and 70 degrees Celsius, such as between 55 and 65 degrees Celsius, such as between 55 and 60 degrees Celsius, such as about 57 degrees Celsius.

An advantage of using heated air could be that an efficient desorption of ammonia from the initial aqueous mixture to the desorbing gas phase is achieved. By using air having a relative high humidity, such higher that 80%, an efficient process can be achieved even at air temperatures being below 75 degrees Celsius, such as below 70 degrees Celsius, such as below 65 degrees Celsius, such as below 60 degrees Celsius. Thus, the inventive process where humid and heated air is used, provides for a more energy efficient process compared to processes where temperatures above 80 degrees Celsius are applied, such as 100 degrees Celsius.

In an embodiment of the invention, the humid, heated air has a relative humidity of more than 80%, such as more than 85%, such as more than 90%, such as more than 95% and a temperature of between 50 and 75 degrees Celsius. In an embodiment of the invention, the humid, heated air has a relative humidity of more than 80%, such as more than 85%, such as more than 90%, such as more than 95% and a temperature of between 50 and 75 degrees Celsius, such as between 50 and 70 degrees Celsius, such as between 55 and 65 degrees Celsius, such as between 55 and 60 degrees Celsius, such as about 57 degrees Celsius. In an embodiment of the invention, the humid, heated air has a relative humidity of more than 80% and a temperature of between 55 and 60 degrees Celsius.

In an embodiment the process is performed at preferably ambient pressure, such as atmospheric pressure, for example at about 1 atm. The present invention provides for a process where none of the process steps are performed at high pressure. Thus, no high pressure equipment is needed for the present inventive process. Nor is any high-pressure safety aspect to be considered.

In an embodiment the process is performed at temperatures below 100 degrees Celsius, such as below 80 degrees Celsius, such as below 75 degrees Celsius, such as below 70 degrees Celsius, such as below 65 degrees Celsius, such as below 60 degrees Celsius.

When the present inventive process is performed at temperatures below 100 degrees Celsius, it becomes highly energy-efficient compared to processes relying on high temperatures for e.g. evaporation etc., since no excessive energy is consumed in order to reach high temperatures, such as above 100 degrees Celsius or significantly higher.

In an embodiment the process does not comprise a step of adding chemical additives. In other words, no chemical additives are added during the process. As understood here, chemical additives do not include carbon dioxide. One advantage of the above embodiment may be that the process is more cost-effective and resource-effective. The process does not rely on the addition of chemical additives. Hence, the inventive process may be more cost-effective compared to processes where often significant amounts additives are needed, such as precipitation agents and/or pH regulating agents.

In an embodiment the process does not comprise any pH adjusting step.

In an embodiment the initial aqueous mixture is essentially free from solid content. The solid content of the initial aqueous mixture may advantageously be very low, as an undesirable high solid content could impair the process, such as by causing clogging of the equipment, by decreasing the effectiveness of the desorbing process etc. Depending on the desorption technology, e.g. density of packing material, low maintenance requirements, etc., various amounts and dimensions of solids may be acceptable. An acceptable low content of solids could be obtained by filtering or sedimentation of a waste source in order to obtain an initial aqueous mixture having an acceptable solid content.

As understood here, “essentially free from solid” may refer to a mixture comprising less than 5% (w/w) of solid material, such as less than 3% (w/w) of solid material, such as less than 1% (w/w) of solid material.

In an embodiment the initial aqueous mixture is a solution. An advantage of the above embodiment could be that a more functioning and efficient process is achieved. The inventive process could have a desirable low downtime compared to processes where clogging of equipment or accumulation of solid material within the equipment might occur. An initial aqueous solution could be achieved directly as a leachate or via filtration, sedimentation or precipitation of a mixture having a solid content.

In an embodiment the initial aqueous mixture is an extract from an ammonium-containing waste source, e.g. a leachate or filtered waste water. Nitrogen sources contained within solid waste material could advantageously be extracted either directly into an aqueous mixture or into an extraction liquid, which upon further processing could be converted into an aqueous mixture, such as by evaporation of the extraction liquid and redissolution of remaining material into an aqueous mixture or by dilution of the extraction liquid with water.

In an embodiment the initial aqueous mixture is a condensate. As understood here, a “condensate” is the result of a condensation of gas into liquid, i.e. the result of gas being converted into liquid. The gas may for example be gas produced in connection with composting of organic mass.

In an embodiment the condensate is provided by condensation of an initial gas comprising ammonia and carbon dioxide. In an embodiment the process further comprises initial steps of providing an initial gas and condensing said initial gas. An initial gas is passed through a condenser or cooler in order to achieve the condensate being the initial aqueous mixture. The process can advantageously recover ammonia from both aqueous sources, solid sources and/or gaseous sources.

In an embodiment the initial gas is condensed to form the initial aqueous mixture. The initial aqueous mixture comprises ammonium ions and ammonium salts. During condensation of the initial gas comprising ammonium and carbon dioxide, salt of the two components will form, such as ammonium bicarbonate (NH4HCO3), ammonium carbonate ((NH4)2CO3), ammonium carbamate (NH2COONH4) or a combination thereof. Also, gaseous ammonia will react with water forming ammonium hydroxide. It is understood, that minor amounts of uncharged ammonia, i.e. ammonia gas might be present in the initial aqueous mixture, when derived via condensation of gases. It is understood, that minor amounts of carbon dioxide gas might be present in the initial aqueous mixture, when derived via condensation of gases.

In an embodiment the initial aqueous mixture is derived from a composting process. The initial aqueous mixture may advantageously be derived by condensation of gas formed during a composting process. In an embodiment the initial gas is a composting gas obtained from a composting process. A composting process may produce composting gas comprising both ammonia and carbon dioxide, which composting gas may advantageously be used as the initial gas condensed into the initial aqueous mixture.

In an embodiment the process further comprises a step of composting organic mass to provide the composting gas. In an embodiment the composting gas is the atmospheric gas from a composting process. In an embodiment the composting process is an aerobic composting process.

During composting aerobic microorganisms may convert all or substantially all of the nitrogen-containing compounds found in biomass, such as amino acids, proteins etc. into ammonia and carbon dioxide. The composting atmosphere comprising said ammonia and carbon dioxide may advantageously be used as the initial gas and/or capture gas in various embodiments of the invention. Thus, during a composting process a composting gas is formed, from where ammonia could be recovered in an effective way in accordance with the invention.

Also, a composting process generates heat. The composting atmosphere will have an increased temperature and humidity, which might facilitate an increased content of ammonia gas and carbon dioxide within the composting atmosphere. Hence, a composting process provides for a highly advantageous gas for use as initial gas or forming of initial aqueous mixture for an ammonia recovery process, for example according to the present invention, having a desirable humidity and temperature.

The composting container comprises a mass inlet where organic mass is received, and a mass outlet where composted material is offloaded. The organic mass may be introduced and offloaded manually or automatically. In an advantageously embodiment, the organic mass is introduced and offloaded automatically.

The microorganism facilitating the composting process may be found in the provided organic mass. Alternative or in addition, microorganisms may be added to the composting process. Microorganism may be added when composting is initiated or during the process, such as if the composting rate is too low or if specific microorganisms are needed to compost certain organic mass added.

In an embodiment the initial gas, such as composting gas, has a relative humidity of more than 80%. The initial gas could advantageously have a relative high humidity of above 80%. A high humidity may facilitate a relative high ammonia and carbon dioxide content, and thereby may enable a desirable high recovery of ammonia from the composted material. Advantageously, the initial gas could have relative humidity of more than 80%, such as more than 90%, such as being 100%.

In an embodiment the initial gas, such as composting gas, has a temperature preferably above 55 degrees Celsius, and preferably below 70 degrees Celsius, such as for example preferably between 55 and 70 degrees Celsius. In an embodiment the composting process is performed at a temperature between 55 and 70 degrees Celsius. Advantageously, the initial gas could have temperature above 55 degrees Celsius. A relative high temperature may facilitate a relative high ammonia and carbon dioxide content, and thereby may enable a desirable high recovery of ammonia from the composted material.

The composting process may be performed within a container, comprising means for measuring the temperature within the container. The temperature is advantageously kept in between 55-70 degrees Celsius in order to ensure optimum metabolic activity of the microorganism facilitating the composting process. The container may advantageously be insulated in order to minimize undesirable temperature fluctuations during the composting process, or to minimize the need for external application of heat. Furthermore, the insulation may enable for recycling of the generated excess heat to be used in other process steps. The temperature of the composting process may be regulated by adjusting air and gas flow within the composting container. If the temperature is too high, the air or gas flow may be increased in order to lower the temperature. Likewise, if the temperature is too low, the air or gas flow could be decreased, thereby allowing the temperature to raise. Alternative or in addition, the temperature may be regulated by adding water. If the temperature is too high, water having a lower temperature may bee added in order to lower the temperature within the composting container. A low temperature may also be an indication of low microbial activity. In such case, it may be advantageous to add microbes to the composting container, such as to boost the microbial activity.

An initial gas having a relative humidity of more than 80% and a temperature between 55 and 70 degrees Celsius may enable a desirably high content of ammonium gas and carbon dioxide to be present in the initial gas. Such an initial gas may for example advantageously be formed during aerobic composting of biomass.

In an embodiment the initial gas, such as composting gas, comprises ammonia and carbon dioxide in an [ammonia:carbon dioxide]-ratio of no more than 1:5, such as no more than 1:10, such as no more than 1:20, such as no more than 1:30, for example an [ammonia:carbon dioxide]-ratio of between 1:5 and 1:30.

By having an excess of carbon a dioxide available, a higher amount of the ammonium reacts with carbon dioxide and water to form ammonium salts, thereby increasing the overall ammonium recovery. The content of the initial gas may be measured using a gas detector/analyzer.

In an embodiment of the invention, the initial gas is composting gas provided from a composting process, in which case the initial gas may comprise ammonia and carbon dioxide in an [ammonia:carbon dioxide]-ratio of at least 1:30. This could advantageously ensure, that the composting rate is desirable high. The metabolic activity of the aerobic microorganisms may decrease if the oxygen level is too low. A high level of carbon dioxide may indicate a low level of oxygen. Furthermore, anaerobe degradation may increase if high levels of carbon dioxide are combined with low levels of oxygen.

In an embodiment the initial gas, such as composting gas, comprises carbon dioxide in an amount of at least 50,000 ppm, such as at least 70,000 ppm, such as at least 100,000 ppm. In an embodiment the initial gas, such as composting gas, comprises carbon dioxide in an amount of at least 50,000 ppm and oxygen in an amount of at least 100,000 ppm. In an embodiment of the invention the initial gas, such as composting gas, comprises around 50,000-200,000 ppm, e.g. 100,000 ppm, of carbon dioxide and about 100,000-200,000 ppm of oxygen.

In an embodiment the initial gas, such as composting gas, is used as the capture gas. In an advantageous embodiment of the invention, the initial aqueous mixture is provided from an initial gas comprising carbon dioxide in an amount of at least 50,000 ppm. In such case, the initial gas could advantageously also be applied as capture gas to mix with the desorbing gas phase, thereby simplifying the process and removing the need for an additional carbon dioxide gas supply to be used as capture gas. In an embodiment, the capture gas is derived from the composting gas through condensing away most of the water and ammonia content, for example for use as input to the deformer as described herein. Since no additional chemicals or external carbon dioxide are thereby added in the recovering process, the recovery process may achieve certification as an organic production of the recovered nitrogen sources.

In an embodiment the humid, heated air has been obtained using heat from a composting process. A composting process generates heat. This heat could advantageously be used to heat the air needed to provide the humid, heated air.

In an embodiment the process further comprises an absorption step. As understood here, “absorption” is the process where substances in a gas phase are transferred to a liquid phase. Absorption processes could also be referred to as scrubbing processes. The absorption step may capture gaseous ammonia into water.

In an embodiment the absorption step is downstream to the desorber. Processes where absorption is performed as the first step often rely on either a pH adjusting step, i.e. alkalizing step, or heating of the liquid ammonia source in order to absorb ammonia from the liquid ammonia source into a gas phase. Advantageously, by performing a desorption prior to the absorption in accordance with the present disclosure, the process does not require any pH adjustment or heating. Thus, the present inventive process may be more cost-effective, less energy-consuming and without addition of further chemicals.

In an embodiment the process further comprises the step of absorbing ammonia from the outlet gas using absorption water to obtain an absorbing liquid phase comprising ammonium salts and ammonium ions, and an absorbing gas phase. This provides for an advantageous way of recovering any ammonia being left in the outlet gas after the condensation. Any or most remaining ammonia will be absorbed into the absorption water, to achieve an absorption liquid phase. The outlet gas also comprises carbon dioxide, hence also some of the carbon dioxide will be absorbed into the absorption water to achieve an absorbing liquid phase comprising ammonium ions and ammonium salts. It is understood, that minor amounts of ammonia gas will be present in the absorbing liquid phase.

In an embodiment the absorption water comprises, or is, water. In an embodiment the desorbing liquid phase is used as the absorption water. According to the above embodiment, the desorbing liquid phase could advantageously be recycled within the inventive process. As the desorbing liquid has an advantageously low content of ammonia, it can advantageously be used as an absorption water supply if an absorption process is included in the recovery process. This provides for an attractive recycling of otherwise waste-water.

In an embodiment the process further comprises the step of separating the absorbing gas phase. In an embodiment the absorbing gas phase has an ammonia content of below 100 ppm, such as below 50 ppm, such as below 20 ppm, such as below 10 ppm. In an embodiment of the invention, the absorbing gas phase, i.e. the gaseous output of an absorption process step, is essentially free of ammonia. Thus, the inventive process enables efficient recovery of ammonia while also providing an absorbing gas phase having a low content of ammonia, such as being essentially free of ammonia. The absorbing gas phase could be discharged without causing ammonia-related inconvenience, such as smell and lung irritation, or harm to the environment.

In an embodiment the absorbing gas phase has a carbon dioxide content of above 40,000 ppm, such as above 60,000 ppm, such as above 100,000 ppm. Due to the attractive high content of carbon dioxide, the absorbing gas phase could advantageously be used as a carbon dioxide source for further processing into valuable product. Also, the absorbing gas phase could be used as green house atmosphere due to its high content of carbon dioxide. If the carbon dioxide concentration in the absorbing gas phase is above 50,000 ppm, it can also be recirculated as capture gas.

An aspect relates to an ammonia recovery system for performing ammonium recovery, the system comprising a desorber configured to receive an initial aqueous mixture at a liquid inlet and discharge a desorbing liquid phase at a liquid outlet, and to receive a humid, heated air at a gas inlet and discharge a desorbing gas phase at a gas outlet; a supply of a capture gas comprising carbon dioxide in an amount of at least 50,000 ppm, the system being configured to mix the desorbing gas phase with the capture gas to form a gas mixture; and a condenser configured to receive the gas mixture at a gas inlet and discharge an outlet gas at a gas outlet and a condensate at a liquid outlet. The initial aqueous mixture comprises ammonium ions and ammonium salts, and the desorber being configured to desorb ammonium ions and ammonium salts from the initial aqueous mixture into the desorbing gas phase so that the desorbing liquid phase comprises ammonium ions and ammonium salts in a total concentration of less than 100 ppm. The condenser is configured to condense the gas mixture to form the condensate comprising a higher total concentration of ammonium ions and ammonium salts than the total concentration in the initial aqueous mixture.

In an embodiment the connections are in the form of pipes or tubes.

In an embodiment the ammonia recovery system further comprises an absorber configured to absorb ammonia into ammonium ions and ammonium salt of the absorbing liquid phase. In an embodiment the absorber is configured to receive the outlet gas at a gas inlet and discharge an absorbing gas phase at a gas outlet, and to receive absorption water at a liquid inlet and discharge absorbing liquid phase at a liquid outlet. In an embodiment the ammonia recovery system comprises a water cooler to cool the absorption water, preferably below 30 degrees Celsius. In an embodiment the ammonia recovery system is configured to use the desorbing liquid phase as the absorption water.

In an embodiment the ammonia recovery system is configured to supply the absorption liquid phase comprising ammonium ions and ammonium salts into the desorber as the initial aqueous mixture for up-concentration.

In an embodiment the ammonia recovery system comprises a humidifier configured to generate the humid, heated air, preferably from humidification water and humidification air. In an embodiment the ammonia recovery system is configured to use the desorbing liquid phase as the humidification water.

In an embodiment the ammonia recovery system is configured to supply the condensate comprising a ammonium ions and ammonium salts into the desorber as the initial aqueous mixture for up-concentration.

In an embodiment the ammonia recovery system comprises an initial gas condenser, e.g. a composting gas condenser, configured to receive an initial gas, e.g. a composting gas, comprising ammonia, and discharge the initial aqueous mixture at a liquid outlet. In an embodiment the initial gas, e.g. a composting gas, comprises carbon dioxide, and the initial gas condenser, e.g. composting gas condenser, is further configured to discharge gas containing at least 50,000 ppm of carbon dioxide at a gas outlet connected to said supply of capture gas.

In an embodiment the ammonia recovery system is connected to a composting system configured to compost organic mass 70 into compost 71 and discharge a composting gas comprising ammonia or an initial aqueous mixture comprising ammonium ions and ammonium salts. In an embodiment the composting system comprises an essentially gas tight composting container and means for controlling a composting atmosphere in the composting system to maintain an aerobic composting process. In an embodiment the composting system comprises means for agitating composting mass and microorganisms in the composting container. In an embodiment the composting system comprises a gas inlet for receiving composting regulating gas, e.g. comprising carbon dioxide above atmospheric air levels, e.g. the gas discharged from the composting gas condenser.

In an embodiment the ammonia recovery system is configured to use composting heat from the composting system for generating the humid, heated air, e.g. in a humidifier.

In an embodiment the ammonia recovery system is connected to a green house facility to receive the outlet gas or absorbing gas phase.

In an embodiment the aqueous mixture supply comprises an initial condenser and an initial gas supply, wherein the initial gas supply is condensed within the condenser to obtain the aqueous mixture in the aqueous mixture supply.

In an embodiment the ammonia recovery system comprises at least one liquid pump configured to cause circulation of said initial aqueous mixture, at least one means for moving air configured to cause circulation of said gas mixture, and preferably at least one valve configured to control flow of said initial aqueous mixture.

In an embodiment the ammonia recovery system is arranged to carry out any of the above-described embodiments of an ammonia recovery process.

An aspect relates to a composting system comprising a composting container for performing composting of composting mass, and means for agitating said composting mass. The composting container is configured to receive organic mass at a mass inlet and discharge compost at a mass outlet, wherein the composting container is essentially gas tight and is configured to allow discharge of a composting gas comprising ammonia and carbon dioxide. The composting system further comprises means for estimating temperature and gas content within said composting container, and controlling means configured to regulate gas content and/or temperature within said composting container to control the composting of organic mass.

In an embodiment the composting system is configured for aerobic fermentation. In an embodiment the composting system comprises means for measuring mass volume or composting fill level within said composting container. In an embodiment the composting system comprises insulation material, preferably wherein the composting container is insulated. Thereby improved control of composting temperature and/or improved recoverability of the produced heat may be obtained. In an embodiment the composting container has a cylindrical shape. In an embodiment the means for agitating comprises rotating means, preferably inside said composting container. In an embodiment the composting system is configured to compost organic mass as a continuous process. In an embodiment said composting system is configured for controllably moving said composting mass from said mass inlet towards said mass outlet to create a mass flow. In an embodiment said composting system is configured to receive a composting regulating gas at a gas inlet. In an embodiment the composting system comprises at least one control unit. In an embodiment the at least one control unit enables regulation of agitation, gas content/flow, temperature, mass flow, and/or filling degree.

An aspect relates to a composting process comprising providing composting mass comprising microorganisms into an essentially gas tight composting container, establishing a composting fill level below 70% by volume of the composting container, enabling a flow of gas between a supply of composting regulating gas and composting gas comprising ammonia and carbon dioxide, agitating said composting mass, and discharging compost from the composting container.

In an embodiment the process further comprises a step of adding microorganisms into the composting container. In an embodiment said agitation is performed by rotating the composting container. In an embodiment the rotation of the composting container is between 3-15 min per rotation. In an embodiment the composting process is performed over 4-8 days. In an embodiment the composting process provides compost after e.g. 7 days. In an embodiment the composting process is a continuous process.

In an embodiment the composting process is carried out by a composting system according to any of the above-described embodiments of composting systems.

An aspect relates to a system for composting organic mass and recovering ammonia. The system comprises a compositing system comprising a composting container for performing composting of composting mass, and means for agitating said composting mass, wherein the composting container is configured to receive organic mass at a mass inlet and discharge compost at a mass outlet, the composting container is essentially gas tight and is configured to allow discharge of a composting gas comprising ammonia and carbon dioxide. The system further comprises an ammonia recovery system comprising: a composting gas condenser configured to condense said composting gas into an initial aqueous mixture comprising ammonium ions and ammonium salts, a desorber configured to receive the initial aqueous mixture at a liquid inlet and discharge a desorbing liquid phase at a liquid outlet, and to receive a humid, heated air at a gas inlet and discharge a desorbing gas phase at a gas outlet; a supply of a capture gas comprising carbon dioxide in an amount of at least 50,000 ppm, the system being configured to mix the desorbing gas phase with the capture gas to form a gas mixture; and a condenser configured to receive the gas mixture at a gas inlet and discharge an outlet gas at a gas outlet and a condensate at a liquid outlet. The desorber is configured to desorb ammonium ions and ammonium salts from the initial aqueous mixture into the desorbing gas phase so that the desorbing liquid phase comprises ammonium ions and ammonium salts in a total concentration of less than 100 ppm. The condenser is configured to condense the gas mixture to form the condensate comprising a higher total concentration of ammonium ions and ammonium salts than the total concentration in the initial aqueous mixture.

In an embodiment the system comprises a control unit.

In an embodiment the ammonium recovery system further comprises an absorber configured to absorb ammonia into ammonium ions and ammonium salt of the absorbing liquid phase. In an embodiment the absorber is configured to receive the outlet gas at a gas inlet and discharge an absorbing gas phase at a gas outlet, and to receive absorption water at a liquid inlet and discharge absorbing liquid phase at a liquid outlet. In an embodiment the outlet gas and/or absorbing gas phase is recirculated to use as composting regulating gas in the composting system.

In an embodiment the composting system further comprises means for estimating temperature and gas content within said composting container, and controlling means configured to regulate gas content and/or temperature within said composting container to control the composting of organic mass. In an embodiment said humid, heated air is heated by heat supply, preferably from said composting system. In an embodiment said humid, heated air is humidified by a humidifier. In an embodiment the system is connected to a green house facility.

In an embodiment the composting system is implemented according to any of the above-described embodiments of a composting system or is arranged to carry out any of the above-described embodiments of a composting process.

In an embodiment the ammonia recovery system is implemented according to any of the above-described embodiments of an ammonia recovery system or is arranged to carry out any of the above-described embodiments of a process of ammonia recovery.

### DRAWINGS

The invention will be explained in further detail below with reference to the figures of which

FIG. 1 schematically illustrates an ammonium recovery system,

FIG. 2 schematically illustrates a process for recovering ammonia according to embodiments of the invention,

FIG. 3 shows a further example of a process for recovering ammonia in accordance with the present disclosure, and

FIG. 4 shows a further example of a process for recovering ammonia in accordance with the present disclosure, comprising an absorber,

FIG. 5 shows a further example of a process for recovering ammonia in accordance with the present disclosure, using recycling of biproducts,

FIG. 6 shows a further example of a process for recovering ammonia in accordance with the present disclosure, wherein the ammonia is recovered from a composting system,

FIG. 7 shows a further example of a process for recovering ammonia in accordance with the present disclosure, wherein the ammonia is recovered from a composting system, using recycling of biproducts,

FIG. 8 shows schematically an example of a composting system, and

FIGS. 9 and 10 show combined composting system and recovery system according to various embodiments.

### DETAILED DESCRIPTION

The invention will be described in detail with reference to the following examples. It should be noted that the examples are provided herein only for the purpose of making further illustration of the invention instead of limiting the scope of the invention. Certain nonessential modifications and alterations may be made by those skilled in the art according to the above description of the invention.

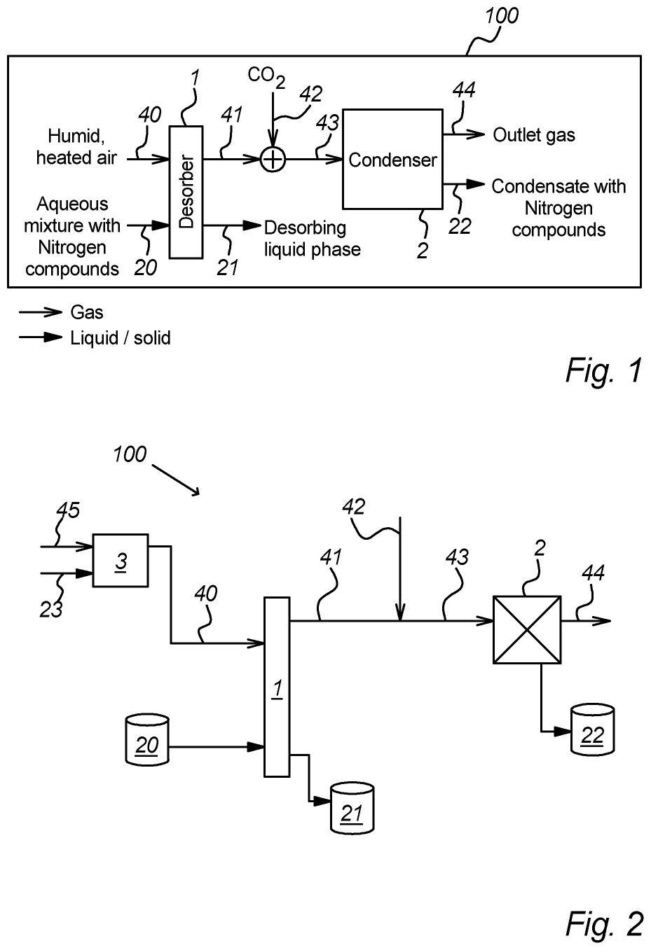

FIG. 1 schematically illustrates an ammonium recovery system 100, comprising a desorber 1 and a condenser 2. An aqueous mixture 20 comprising ammonium compounds such as ammonium ions and ammonium salts, e.g. ammonium bicarbonate (NH4HCO3), ammonium carbonate ((NH4)2CO3), ammonium carbamate (NH2COONH4) or a combination thereof, is provided to the desorber 1, together with humid, heated air 40. From the desorber 1 is produced a desorbing gas phase 41 and a desorbing liquid phase 21. The desorbing is configured so that most of the ammonium compounds leaves the desorber 1 in the desorbing gas phase 41, and the desorbing liquid phase 21 therefore primarily contains water with only a small amount of ammonium compounds, for example water with less than 100 ppm of ammonium ions and ammonium salts. In the present disclosure, ammonia, ammonium salts and ammonium ions are also sometimes referred to as nitrogen compounds.

The desorbing gas phase 41 is mixed with a capture gas 42 comprising carbon dioxide. The gas mixture 43 is cooled in the condenser 2, whereby a condensate 22 comprising ammonium ions and ammonium salts is produced, together with an outlet gas 44. By means of the desorbing and condensation, the concentration of ammonium ions and ammonium salts is higher in the produced condensate 22 than in the initial aqueous mixture 20.

With reference to FIG. 2, an example of a process for recovering ammonia according to embodiments of the invention will be elucidated. This figure shows schematically a process performed in a recovery system 100 similar to the system described with reference to FIG. 1 above. Elements with same reference numeral refers to same or similar elements, and as in FIG. 1, the open arrows indicate gas phases, and closed arrows indicate liquid/solid phases. Further to the system shown in FIG. 1, the process in FIG. 2 comprises a humidifier 3 which uses humidification air 45 and humidification water 23 to produce the humid, heated air 40 used in the desorber 1.

Optimal desorbing conditions may in an embodiment be obtained by supplying of a humid, heated air 40 generated in the humidifier 3 having e.g. a relative humidity (RH) of 95%, comprising e.g. 400 ppm of carbon dioxide, and with a temperature from 50-65 degrees C. The humidifier 3 may be any suitable component for generating humid, heated air 40.

The capture gas 42 is not necessarily pure or highly concentrated carbon dioxide, but may for example be atmospheric air with increased carbon dioxide concentration, or advantageously a waste or byproduct gas from another process, e.g. combustion or composting of carbon-based material, e.g. organic matter. The capture gas 42 may in an embodiment comprise at least 5% carbon dioxide, i.e. 50,000 ppm, to obtain a gas mixture 43 suited for the condensation in the condenser 2.

In the present disclosure, condensing and cooling, and condenser and cooler, may be referring the same process and component, and used interchangeably. Likewise for desorbing and stripping, and desorber and stripper, respectively.

According to embodiments of the invention, a desorber 1 may be cylindrical chamber having a substantial circular cross-section, also referred to as column. According to embodiments of the invention, the desorber 1 is positioned vertically when installed and/or when in operation. Although for schematic simplicity not shown like this in the drawings, at least internally in a preferred desorber 1 the inlet for the humid, heated air 40 and the outlet for the desorbing liquid phase 21 are positioned near the bottom of the desorbing column, whereas the inlet for the initial aqueous mixture 20 and the outlet for the desorbing gas phase 41 are positioned near the top. Thereby the gas phase is generally moving upwards inside the desorbing column, whereas the liquid phase is generally moving downwards, while desorbing ammonia to the passing gas phase. The desorber 1 may in an embodiment be a packed bed stripper, i.e. a desorber column containing packing material through which the liquid phase and gas phase is passing in opposite directions, but other desorber/stripper types can be used. Examples of packing material may be rings, cylinders, saddles, structured packing batts, etc., and for small application also mesh or filter materials. An example of a desorber dimension for a small ammonia recovery system, may be a diameter of 75 mm and a height of 1100 mm. The dimensions and packing material should preferably be selected based on the estimated flow rate and compositions of the supplied gas and liquid, and with a balancing between desired desorbing efficiency on one hand, and required maintenance effort, off-duty hours and costs, on the other.

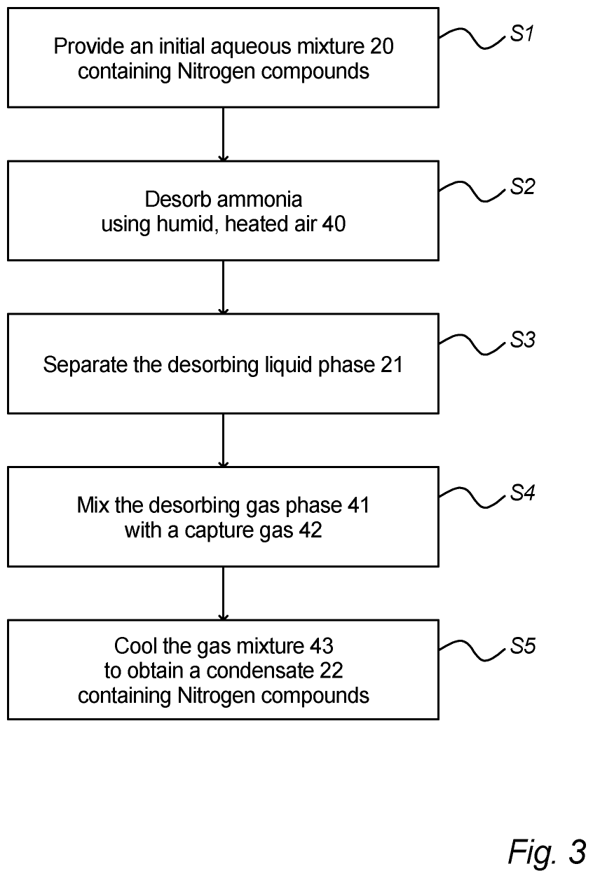

FIG. 3 illustrates a process of an embodiment of the invention as a flow chart. In step S1, an initial aqueous mixture 20 containing ammonium compounds such as ammonium ions and ammonium salts is provided. Step S2 involves using humid, heated air 40 to desorb ammonia from the initial aqueous mixture 20. The resulting desorbing liquid phase 21 is separated in step S3, whereas the desorbing gas phase 41 containing most of the ammonia is mixed with a capture gas 42 in step S4. The resulting gas mixture 43 is in step S5 cooled to obtain a condensate 22 containing nitrogen compounds stemming from the ammonia in the gas mixture. In an embodiment, the process in FIG. 3 may be implemented according to the description of FIG. 1 or 2 above. Other embodiments will be provided below.

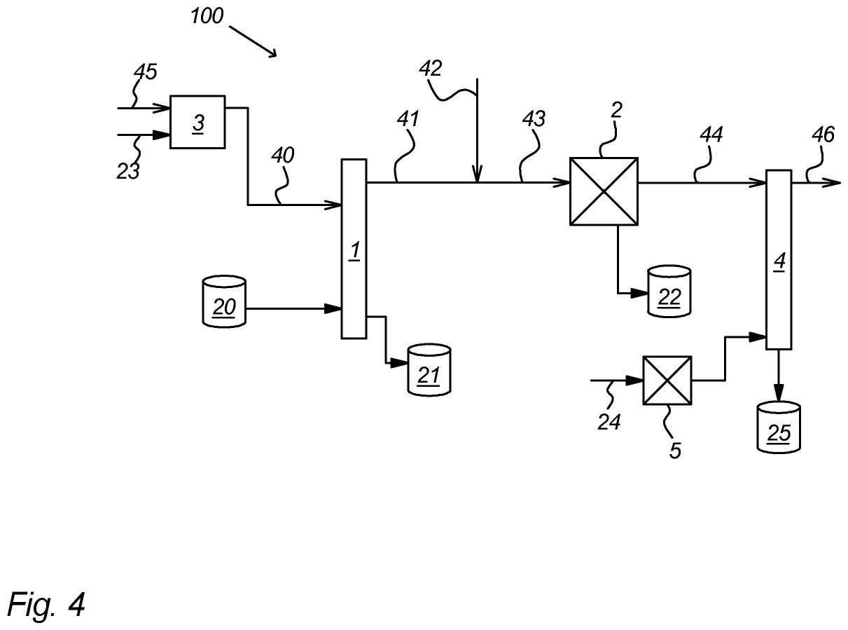

FIG. 4 shows an embodiment of a process for recovering ammonia like any of the above, however, with more process steps. Elements with same reference numeral refers to same or similar elements, and as above the open arrows indicate gas phases, and closed arrows indicate liquid/solid phases. Similar to the embodiment of FIGS. 1 and 2, and with the implementation options and considerations described above, a nitrogen-containing condensate 22 is obtained in a condenser 2 from a nitrogen-containing initial aqueous mixture 20, where the condensate 22 has a higher concentration of ammonium ions and ammonium salts than the initial aqueous mixture 20.

Further, the embodiment of FIG. 4 comprises an absorber 4 arranged to receive the outlet gas 44. The absorber 4 is further connected to a supply of absorption water 24, possibly through a water cooler 5 to increase the efficiency of the absorber. From the absorber is obtained an absorbing liquid phase 25 comprising nitrogen compounds such as ammonium ions and salts. Further, and absorbing gas phase 46 is output.

The supply of absorption water 24 may be a water source such as tap water or may for example be water as a byproduct from another process, or, as will further be elucidated below, the desorbing liquid phase 21. Both the outlet gas 44 and the absorption water 24 should preferably be below 30 degrees C. when entering the absorber 4.

In the present disclosure, absorbing and scrubbing, and absorber and scrubber, respectively, may be referring to the same process and component, and used interchangeably. According to embodiments of the invention, an absorber 4 may be a cylindrical chamber having a substantial circular cross-section, also referred to as column. According to embodiments of the invention, the absorber is positioned vertically when installed and/or when in operation. Although for schematic simplicity not shown like this in the drawings, at least internally in a preferred absorber 4 the inlet for the gas mixture 44 and the outlet for the absorbing liquid phase 25 are positioned near the bottom of the absorbing column, whereas the inlet for the absorption water 24 and the outlet for the absorbing gas phase 46 are positioned near the top. Thereby the gas phase is generally moving upwards inside the absorbing column, whereas the liquid phase is generally moving downwards, while absorbing ammonia from the passing gas phase. The absorber 4 may in an embodiment be a wet scrubbing absorber, e.g. a packed bed scrubber, i.e. an absorber column containing packing material through which the liquid phase and gas phase is passing in opposite directions, but other absorber/scrubber types can be used. Examples of packing material may be rings, cylinders, saddles, structured packing batts, etc., and for small application also mesh or filter materials. An example of an absorber dimension for a small ammonia recovery system, may be a diameter of 50 mm and a height of 1100 mm. The dimensions and packing material should preferably be selected based on the estimated flow rate and compositions of the supplied gas and liquid, and with a balancing between desired absorbing efficiency on one hand, and required maintenance effort, off-duty hours and costs, on the other.

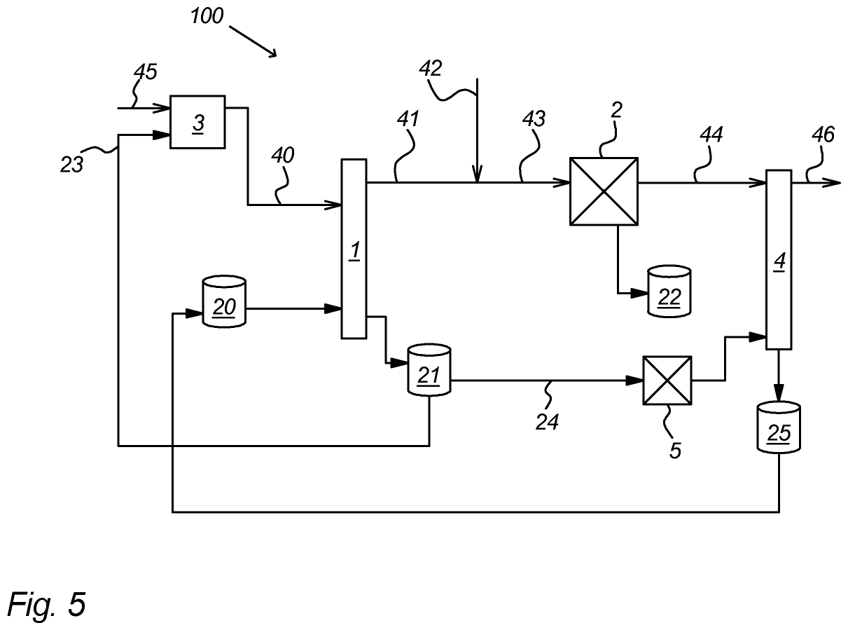

FIG. 5 shows an embodiment of a process for recovering ammonia in accordance with the present disclosure. The embodiment of FIG. 5 includes the same steps and components as described above with reference to FIG. 1-4, subject to the same explanations and considerations, but also includes further steps which may be advantageous in some embodiments.

One of the additional steps in the embodiment of FIG. 5, is using the desorbing liquid phase 21, which primarily consists of water, as the absorption water 24 for the absorber 4.

Another additional step in the embodiment of FIG. 5, is using the desorbing liquid phase 21, which primarily consists of water, as the humidification water 23 for producing the humid, heated air 40 in the humidifier 3.

This re-circulation of water within the process may have the advantage of reusing the resources within the same process or system. The reuse of the desorbing liquid phase water may be an advantageous synergetic effect between the desorption and absorption steps and/or desorption and humidification steps, respectively, as at least some of the byproduct water from the desorber 1 can thereby be reused, and it is avoided to tap clean water for the absorber 4 and/or humidifier 3.

Various embodiments may implement both the described re-uses of desorbing liquid phase 21, or only one of them. The re-use may involve further filtering or purification of the water.

The embodiment of FIG. 5 further shows the additional step that the absorbing liquid phase 25 comprising ammonium ions and ammonium salts may be used as the initial aqueous mixture 20 and thereby recirculated in the process to allow more of the nitrogen compounds to condense in the condenser 2 to form the nitrogen-containing condensate 22. In other words, the embodiment of FIG. 5 comprises a possibility of re-iterating the ammonia that escapes the condenser 2 in the outlet gas 44, to capture essentially all nitrogen from the absorbing liquid phase 25 in the condensate 22.

The re-iteration of absorbing liquid phase 25 may be implemented in embodiments with or without any of the embodiments of re-using desorbing liquid phase described above with reference to FIG. 5, for example in the embodiment of 4.

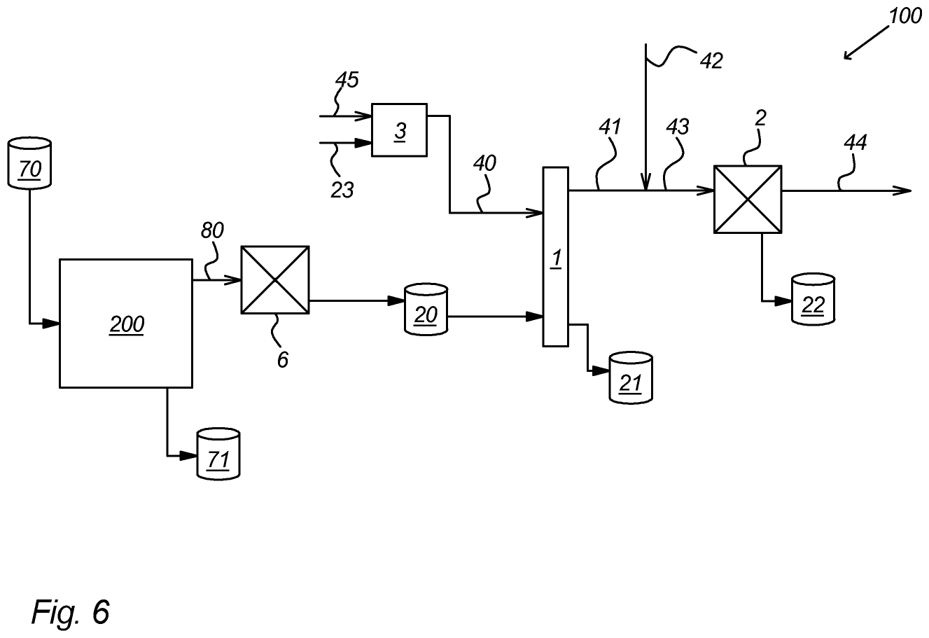

FIG. 6 shows an embodiment of a process for recovering ammonia in accordance with the present disclosure. The embodiment of FIG. 6 includes the same steps and components as described above with reference to FIGS. 1 and 2, and the same explanations and considerations apply. FIG. 6 shows an embodiment of how the initial aqueous mixture 20 can be obtained.

A composting system 200 is provided which is configured to receive organic mass 70 and compost it to produce compost 71. The composting system 200 is preferably configured to perform aerobic composting, preferably in a controlled environment, e.g. in an essentially air-tight composting container and with controlled atmosphere and temperature suitable for the desirable composting microorganisms. The organic mass to be composted may e.g. be plant-based or animal-based, e.g. waste from plant farms, greenhouses, gardens, fishery, animal farms, food production, food distribution, etc., e.g. vegetable production waste, feed production waste, slaughterhouse waste, liquid manure and slurry, biogas, etc., as long as ammonia, ammonium ions or ammonium salts are included in the initial aqueous mixture or initial gas.

A warm, humid composting gas 80 comprising ammonia and carbon dioxide among others is produced by the aerobic composting process of the composting system 200. This composting gas 80 is fed through a composting gas condenser 6, for example an air cooler, whereby the water condenses together with the ammonia to form the initial aqueous mixture 20, from which the rest of the described process, e.g. FIG. 2, starts, and from which the nitrogen-containing condensate 22 is produced at the end.

A composting gas 80 suitable for use in various embodiments of the invention, may for example comprise 50,000-200,000 ppm of carbon dioxide and preferably an accordingly reduced amount of oxygen, compared to atmospheric air. Further, the composting gas 80 may for example have a relative humidity of at least 80% and a temperature from 55-70 degrees C. The ammonia concentration depends on the organic matter being composted and may for example be between 1/10 and 1/30 or the carbon dioxide concentration. Other compositions of the composting gas 80 may also be suitable in various embodiments of the invention.

By using composting gas 80 as initial aqueous mixture 20 is provided an advantageous way of not only removing, but also recovering, ammonia from composting gas. The composting gas 80 may also be referred to as initial gas, and is not limited to being obtained from composting.

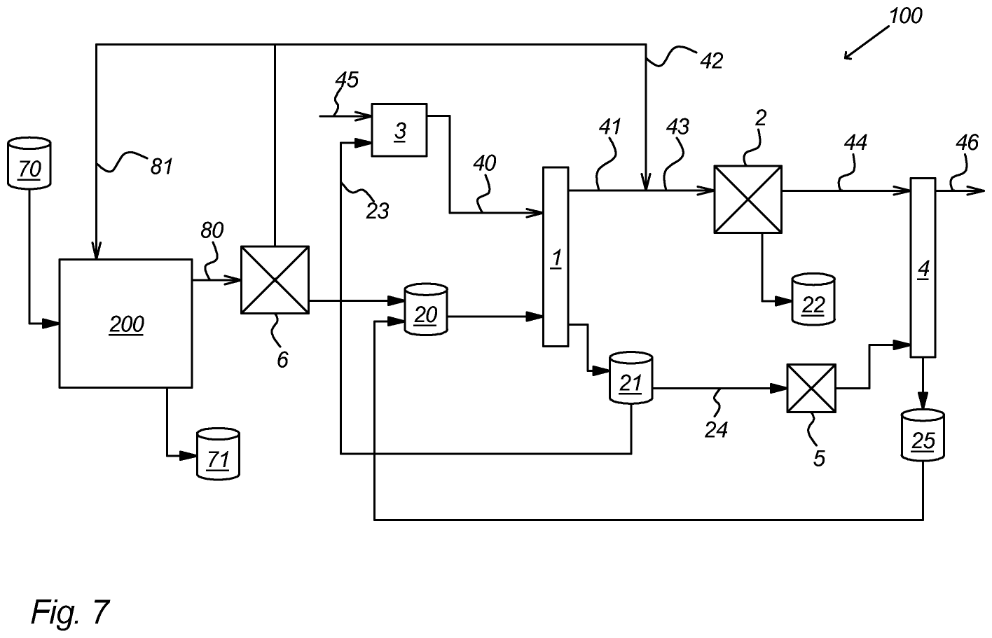

FIG. 7 shows an embodiment of a process for recovering ammonia in accordance with the present disclosure. The embodiment of FIG. 7 includes the same steps and components as described above with reference to FIG. 1-6, subject to the same explanations and considerations, but also includes further steps which may be advantageous in some embodiments. The embodiment of FIG. 7 combines the features of the embodiments of FIG. 5 and FIG. 6, and also provides further features.

One of the additional steps in the embodiment of FIG. 7, is that the condensing of composting gas 80 in the composting gas condenser 6 may, besides producing the initial aqueous mixture 20, also produce a remaining gas with a relatively high carbon dioxide-to-oxygen ratio, compared to normal atmospheric air, as mentioned above. This carbon dioxide containing gas may advantageously be used as capture gas 42 to mix with the desorbing gas phase 41 to obtain the gas mixture 43 to condense in the condenser 2. Besides treating the ammonia from the composting gas 80, the present invention thereby also provides a use for the carbon dioxide in the composting exhaust, instead of simply releasing it to the environment. The composting gas condenser 6 may preferably be controllable and configured based on the incoming composting gas 80, for example to achieve a maximum condensation of ammonia in order to diminish the amount of uncondensed gas leaving the composting gas condenser, such as to diminish or even avoid ammonia being uncondensed.

As shown in FIG. 7, the carbon dioxide-containing gas from the composting gas condenser 6 may, in addition or alternatively, be used as a composting regulating gas 81 to control the composting atmosphere in the composting system 200.

Various embodiments may implement any combination of the additional features of FIG. 7 compared to FIG. 2, according to the explanations, alternatives and considerations described above with reference to FIG. 1-7.

The embodiments described above and other embodiments of the invention, may advantageously comprise means for moving the liquid phases and gas phases through the process, as well as means for controlling the moving. Liquid pumps or other means for moving liquid may for example be applied to move desorbing liquid phase 21 to the absorber 4 as absorption water 24 and/or to the humidifier 4 as humidification water 23. A liquid pump may for example also be implemented to move the initial aqueous mixture to the desorber 1. An air pump or fan or other means for moving air may for example be applied to move the outlet gas 44 from the condenser 2, e.g. to the absorber 4. Similarly, means for moving air may be provided to move capture gas 42 from a composting gas condenser 6 to the place where it should be mixed with the desorbing gas phase 41. Further means for moving liquid or gas may be implemented where suitable, in accordance with the knowledge of the skilled person to achieve a flow of liquid and gas phases through the components as described, e.g. to suck or push liquid or gas from or through desorbers, condensers, absorbers, etc., or to move the liquid or gas between storing containers. Liquid valves and/or gas valves may be implemented at various locations in the process to enable manual or automatic control, e.g. microprocessor or computer control, of the process, e.g. to control the flow of gas and/or liquid through the desorber, condenser and absorber, etc. The means for moving gas or liquid may also be controllable in the same way with regard to the flow rate they generate and/or include valves to prevent flow entirely. Valves may for example in some embodiments be located at the liquid phase inlet and outlet of the desorber, at the liquid phase inlet and outlet of the absorber, etc. Storage containers for liquid and gas, respectively, may in various embodiments be provided where suitable, in particular at inlets where flow is controlled or inherently limited, and at outlets where products may build up before being moved elsewhere. Various suitable control means and power supply means are implemented to power and control pumps, valves, heaters, coolers, etc.

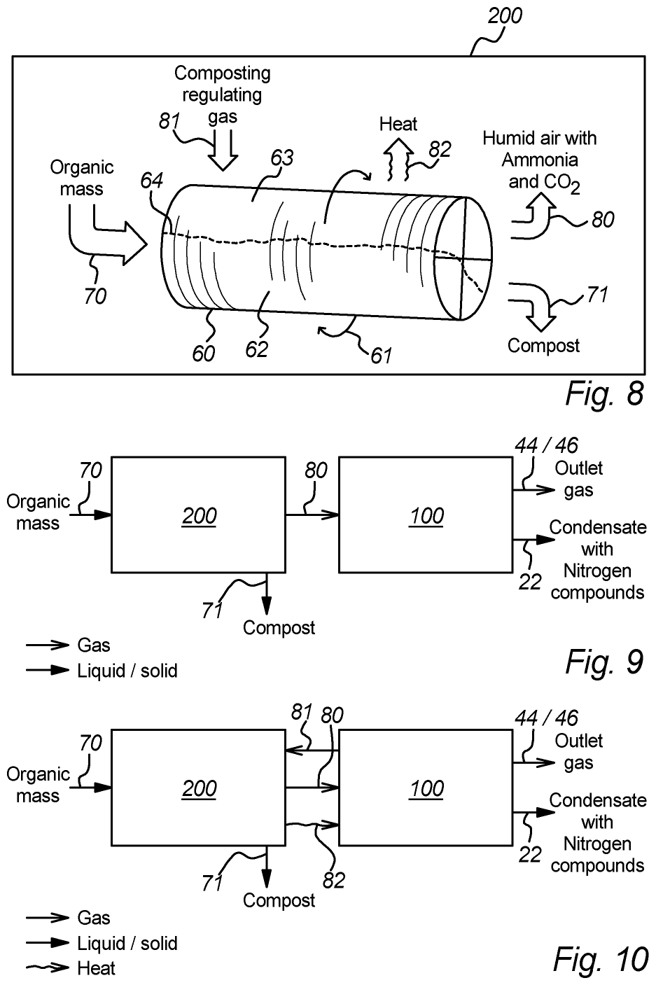

FIG. 8 illustrates schematically a composting system 200 according to the present disclosure. A composting container 60 comprises a composting mass and microorganisms 62 and agitation means (not shown) to agitate 61 the composting mass 62. The composting container 60 is filled with composting mass 62 to a composting fill level 64, and a composting atmosphere 64 develops in the remaining space inside the composting container 60. To establish the composting mass 62 an organic mass 70 is received by the composting system 200. Microorganisms may be included in the organic mass 70 and/or be inoculated into the composting mass 62 inside the composting container 60. A main product of the composting system 200 is compost 71, i.e. completely or partly decomposed organic mass. The composting atmosphere 63 may also be retrieved as composting gas 80 comprising ammonia and carbon dioxide. Further, the composting process produces heat 82, and the composting atmosphere 63 may preferably be controlled, for example by supplying composting regulating gas 81 into the composting container 60.

The agitation means to agitate 61 the composting mass 62 may comprise means for agitating the entire composting container 60, or in preferred embodiments, comprise means inside the composting container 60 to agitate the composting mass, e.g. by stirring, turning, flipping, rotating, mixing, etc.

The composting container 60 is preferably essentially gas tight and/or with a controllable gas tightness, to allow control of the composting process. In preferred embodiments, the composting atmosphere and other parameters are controlled so that an aerobic composting process is accomplished and maintained. In an embodiment the composting container 60 is made of stainless steel or plastic, but other suitable material or coated material which is able to withstand composting conditions may be applied.

The composting container 60 may as illustrated be an enclosed cylindrical container. A cylindrical shape may reduce the possibility of dead spaces, i.e. unmixed pockets. However, any other suitable shapes could be envisioned and used with the present disclosure. A suitable capacity of the composting container 60 may be selected based on the amount and type of organic mass 70, the estimated composting duration for that type and condition of organic mass, and the desired level of decomposition before releasing the composting mass 62 as compost 71. An example of a composting container 60 may be a cylinder with a diameter of 2 m and a length of 9 m. In embodiments of very large composting systems, several composting containers may advantageously be parallel coupled to increase the total volume, as increasing the volume of one composting container is both impractical and suboptimal for the control of the composting process.

In an example of a small composting system 200, with a composting container diameter of 80 cm and a length of 3 m, a supply of 100 kg organic mass 70 per day and with 60% relative humidity, is decomposed during for example 7 days into 30 kg compost 71 per day, while also producing estimated 6 kg carbon dioxide, 60 L water, 30-50 g ammonia and 4 kW of recoverable heat per day.

FIG. 9 illustrates an overview of an embodiment where a composting system 200 is combined with an ammonia recovery system 100, for example implemented as described with relation to FIG. 6 or FIG. 7.

Organic mass 70 is supplied to the composting system 200, and after partial or complete decomposition, the mass is released as compost 71. Further, warm, humid composting gas 80 comprising ammonia and carbon dioxide is supplied to the ammonia recovery system 100, for example to a composting gas condenser 6 as shown in FIG. 6 or FIG. 7. From the ammonia recovery system 100 is released condensate 21 comprising ammonium ions and ammonium salts, as well as outlet gas 44 or absorption gas phase 46. The embodiment of FIG. 9 thereby shows an advantageous combination of composting and ammonia recovery.

FIG. 10 also illustrates an overview of an embodiment comprising both a composting system 200 and an ammonia recovery system 100. This embodiment may also be implemented as described above with relation to FIG. 6 or FIG. 7. In addition to the embodiment of FIG. 9, the composting heat 82 is further utilized advantageously for the heaters and/or coolers (e.g. by heat pump technology) of the ammonia recovery system 100, for example to produce the heated, humid air 40 in the humidifier 3. Further, the embodiment of FIG. 10 shows that composting regulating gas 81 comprising carbon dioxide can be received from the ammonia recovery system 100 and used to control the composting atmosphere 63 of the composting system 200 and to maintain a relatively high concentration of carbon dioxide in the composting gas 80 for optimal condensing in the composting gas condenser 6 and the ammonia condenser 2. The embodiment of FIG. 10 thereby shows an advantageous combination of composting and ammonia recovery.

### LIST OF REFERENCE NUMBERS

100 Ammonia recovery system
1 Desorber/stripper
2 Ammonia condenser
3 Humidifier
4 Absorber/scrubber
5 Water cooler/condenser
6 Composting gas condenser
20 Initial aqueous mixture
21 Desorbing liquid phase
22 Condensate comprising nitrogen compounds
23 Humidification water
24 Absorption water
25 Absorbing liquid phase comprising nitrogen compounds
40 Humid, heated air
41 Desorbing gas phase
42 Capture gas
43 Gas mixture
44 Outlet gas
45 Humidification air
46 Absorbing gas phase
200 Composting system
60 Composting container
61 Agitation
62 Composting mass and microorganisms
63 Composting atmosphere
64 Composting fill level
70 Organic mass
71 Compost
80 Composting gas comprising ammonia and CO₂, Initial gas
81 Composting regulating gas
82 Composting heat

1-91. (canceled)

92. Process for recovering ammonia from an initial aqueous mixture comprising ammonium ions and ammonium salts, the process comprising steps of:
providing an initial aqueous mixture,
desorbing ammonia using humid, heated air to obtain a desorbing liquid phase and a desorbing gas phase,
separating the desorbing liquid phase,
mixing the desorbing gas phase with a capture gas to obtain a gas mixture, and
condensing the gas mixture to obtain a condensate comprising ammonium ions and salt, and an outlet gas,
wherein the desorbing liquid phase comprises ammonium ions and ammonium salts in a total concentration of less than 100 ppm, wherein the capture gas comprises carbon dioxide in an amount of at least 50,000 ppm, and
wherein the total concentration of ammonium ions and ammonium salts in the condensate is higher than the total concentration in the initial aqueous mixture.

93. The process for recovering ammonia of claim 92, wherein the process is performed at atmospheric pressure of about 1 atm., and at temperatures below 100 degrees Celsius.

94. The process for recovering ammonia of claim 92, wherein the process does not comprise a step of adding chemical additives.

95. The process for recovering ammonia of claim 92, wherein the process does not comprise any pH adjusting step.

96. The process for recovering ammonia of claim 92, wherein the initial aqueous mixture is an extract from an ammonium-containing waste source.

97. The process for recovering ammonia of claim 92, wherein the initial aqueous mixture is a condensate provided by condensation of an initial gas comprising ammonia and carbon dioxide.

98. The process for recovering ammonia of claim 97, wherein the process further comprises a step of composting organic mass to provide a composting gas as the initial gas.

99. The process for recovering ammonia of claim 97, wherein the initial gas comprises ammonia and carbon dioxide in an [ammonia:carbon dioxide]-ratio of no more than 1:5.

100. The process for recovering ammonia of claim 97, wherein the initial gas is used as the capture gas.

101. The process for recovering ammonia of claim 92, wherein the process further comprises a step of absorbing ammonia from the outlet gas using absorption water to obtain an absorbing liquid phase comprising ammonium salts and ammonium ions, and an absorbing gas phase.

102. The process for recovering ammonia of claim 101, wherein the desorbing liquid phase is used as the absorption water.

103. The process for recovering ammonia of claim 101, wherein the process further comprises a step of separating the absorbing gas phase.

104. An ammonia recovery system for performing ammonium recovery, the system comprising:
a desorber configured to receive an initial aqueous mixture at a liquid inlet and discharge a desorbing liquid phase at a liquid outlet, and to receive a humid, heated air at a gas inlet and discharge a desorbing gas phase at a gas outlet;
a supply of a capture gas comprising carbon dioxide in an amount of at least 50,000 ppm, the system being configured to mix the desorbing gas phase with the capture gas to form a gas mixture; and
a condenser configured to receive the gas mixture at a gas inlet and discharge an outlet gas at a gas outlet and a condensate at a liquid outlet;
wherein the initial aqueous mixture comprises ammonium ions and ammonium salts, and the desorber being configured to desorb ammonium ions and ammonium salts from the initial aqueous mixture into the desorbing gas phase so that the desorbing liquid phase comprises ammonium ions and ammonium salts in a total concentration of less than 100 ppm; and
wherein the condenser is configured to condense the gas mixture to form the condensate comprising a higher total concentration of ammonium ions and ammonium salts than the total concentration in the initial aqueous mixture.

105. The ammonia recovery system of claim 104, wherein the ammonia recovery system further comprises an absorber configured to absorb ammonia into ammonium ions and ammonium salt of an absorbing liquid phase;
wherein the absorber is configured to receive the outlet gas at a gas inlet and discharge an absorbing gas phase at a gas outlet, and to receive the desorbing liquid phase as absorption water at a liquid inlet and discharge absorbing liquid phase at a liquid outlet; and
wherein the ammonia recovery system is configured to supply the absorption liquid phase comprising ammonium ions and ammonium salts into the desorber as the initial aqueous mixture for up-concentration.

106. The ammonia recovery system of claim 104, wherein the ammonia recovery system is configured to supply the condensate comprising ammonium ions and ammonium salts into the desorber as the initial aqueous mixture for up-concentration.

107. The ammonia recovery system of claim 104, wherein the ammonia recovery system comprises an initial gas condenser configured to receive an initial gas comprising ammonia, and discharge the initial aqueous mixture at a liquid outlet;
wherein the initial gas comprises carbon dioxide, and the initial gas condenser is further configured to discharge gas containing at least 50,000 ppm of carbon dioxide at a gas outlet connected to said supply of capture gas.

108. The ammonia recovery system of claim 104, wherein the ammonia recovery system is connected to a green house facility to receive the outlet gas or absorbing gas phase.

109. A system for composting organic mass and recovering ammonia, said system comprising:
a compositing system comprising:
a composting container for performing composting of composting mass, and means for agitating said composting mass, wherein the composting container is configured to receive organic mass at a mass inlet and discharge compost at a mass outlet, wherein the composting container is essentially gas tight and is configured to allow discharge of a composting gas comprising ammonia and carbon dioxide;
an ammonia recovery system comprising:
a composting gas condenser configured to condense said composting gas into an initial aqueous mixture comprising ammonium ions and ammonium salts;
a desorber configured to receive the initial aqueous mixture at a liquid inlet and discharge a desorbing liquid phase at a liquid outlet, and to receive a humid, heated air at a gas inlet and discharge a desorbing gas phase at a gas outlet;
a supply of a capture gas comprising carbon dioxide in an amount of at least 50,000 ppm, the system being configured to mix the desorbing gas phase with the capture gas to form a gas mixture; and
a condenser configured to receive the gas mixture at a gas inlet and discharge an outlet gas at a gas outlet and a condensate at a liquid outlet;
wherein the desorber is configured to desorb ammonium ions and ammonium salts from the initial aqueous mixture into the desorbing gas phase so that the desorbing liquid phase comprises ammonium ions and ammonium salts in a total concentration of less than 100 ppm; and
wherein the condenser is configured to condense the gas mixture to form the condensate comprising a higher total concentration of ammonium ions and ammonium salts than the total concentration in the initial aqueous mixture.

110. The system of claim 109, wherein at least one of the outlet gas and the absorbing gas phase is recirculated to use as composting regulating gas in the composting system.

111. The system of claim 109, wherein said humid, heated air is heated by heat supply from said composting system.
